(19) United States
(12) Patent Application Publication
(10) Pub. No.: US 2007/0147664 A1
(43) Pub. Date: Jun. 28, 2007

(54) Driving assist method and driving assist apparatus

(75) Inventors: Tomoki Kubota, Okazaki-shi (JP); Toshihiro Mori, Okazaki-shi (JP); Hiroaki Sugiura, Okazaki-shi (JP)

Correspondence Address: BACON & THOMAS, PLLC, 625 SLATERS LANE, FOURTH FLOOR, ALEXANDRIA, VA, 22314, US

(73) Assignee: AISIN AW CO., LTD., Anjo-shi (JP)

(21) Appl. No.: 11/645,163

(22) Filed: Dec. 26, 2006

(30) Foreign Application Priority Data
Dec. 27, 2005 (JP) 2005-375821

(51) Int. Cl. G06K 9/00

(52) U.S. Cl. 382/106

(57) ABSTRACT

A driving assist apparatus obtains image data from a camera mounted on a vehicle and stores the image data in an image memory. The driving assist apparatus further obtains a relative distance between the vehicle and an obstacle on the basis of input from a sonar device mounted on the vehicle, generates a projection plane on the basis of the relative distance between the vehicle and the detected obstacle, and projects the stored image data onto a plane to generate an overhead image.

### INCORPORATION BY REFERENCE

The disclosure of Japanese Patent Application No. 2005-375821 filed on Dec. 27, 2005, including the specification, drawings and abstract thereof, is incorporated herein by reference in its entirety.

### BACKGROUND OF THE INVENTION

1. Field of the Invention

The present invention relates to a driving assist method and to a driving assist apparatus.

2. Description of the Related Art

Driving assist apparatuses for assisting a driver in operation of a vehicle are well known. One type of driving assist apparatus obtains image data through use of an in-vehicle camera which is attached to the rear of the vehicle and outputs the image data as a display on a monitor mounted near the driver's seat. The in-vehicle camera is typically attached to the upper part of the rear bumper of the vehicle and the optical axis of the camera is directed downward, so that an image of the area behind the vehicle obtained by the camera is displayed. Using such an apparatus, it is difficult for the driver to determine the relative distance between a wheel stopper and the vehicle because it is difficult to get a sense of depth from the image displayed on the monitor. In particular, it is difficult for the driver to determine the distance from the image displayed on the monitor when the in-vehicle camera has a wide-angle lens because the image is distorted due to lens aberration of the camera.

To resolve such a problem, an apparatus which provides coordinate transformation of image data obtained by an in-vehicle camera and displays an image as if obtained from a virtual viewpoint, different from the actual viewpoint of the camera, has been proposed. The proposed apparatus provides a virtual viewpoint which is vertically above the actual viewpoint. Moreover, an apparatus with reduced image distortion has been suggested. For example, Japanese Unexamined Patent Application Publication “Kokai”) No. 2004-21307 discloses an apparatus which displays image data projected onto a 3D projection plane including a surface of an elliptical cylinder and a surface of an ellipsoidal body, changes the viewpoint to a virtual viewpoint, and thereby reduces the distortion of the displayed image data.

However, the height of an obstacle near the vehicle can not be determined using a projection plane as disclosed in Kokai 2004-21307. Therefore, when there is an obstacle such as another vehicle near the user's vehicle, an image which includes the area behind the vehicle but which is significantly different from an actual view might be displayed. As a result, it might be difficult for the driver to determine the relative distance between the obstacle and his/her vehicle.

### SUMMARY OF THE INVENTION

Accordingly, it is an object of the present invention to provide a driving assist method and a driving assist apparatus for displaying an overhead image which aids the driver's recognition of the position of his/her vehicle relative to an obstacle near the vehicle “relative position”).

To solve the problems described above, the present invention provides a driving assist method for generating an overhead image of the obstacle and vehicle, as viewed from above, using image data obtained from an imaging device mounted on a vehicle, which method includes the steps of: obtaining a relative distance between the vehicle and an obstacle utilizing an obstacle detection device mounted on the vehicle; capturing images of an area behind the vehicle as the vehicle moves in reverse; upon detection of an obstacle, correlating distances to the obstacle with portions of the images including the obstacle; storing the portions as items of image data; projecting the portions of the images onto a horizontal plane to form an overhead image including the obstacle; and superimposing an overhead image of the vehicle on the overhead image including the obstacle.

Another aspect of the present invention provides a driving assist apparatus in a vehicle, comprising: an image data obtaining device for obtaining image data from an imaging device mounted on the vehicle; a distance obtaining device for detecting an obstacle near the vehicle and obtaining a relative distance between the vehicle and the obstacle; a control section for correlating the relative distance with the image data, the control section including a projection plane generating device for generating a horizontal projection plane on the basis of the relative distance to the obstacle; an overhead image data generating device for projecting the image data onto the projection plane and to generate an overhead image of the obstacle; and an output control device for outputting the overhead image data as a visual display.

In one preferred embodiment the projection plane generating device generates a horizontal (first) plane including a pixel area on the projection plane corresponding to an actual area in which no obstacle is detected and generates a second plane including a pixel area on the projection plane corresponding to an actual area including the detected obstacle, the second plane being oriented at a predetermined angle relative to the horizontal plane based on the relative distance to the obstacle. Images in the second plane, which represent images as seen by the imaging device and therefore change in angle with the horizontal in accordance with the relative distance, are then correlated with virtual distances so that they can be projected onto the first (horizontal) plane to generate an overhead image.

The apparatus of the present invention may further include an image data storage device for storing the image data as stored image data correlated with the relative distance to the obstacle obtained at an imaging position; wherein: the projection plane generating device generates the horizontal projection plane on the basis of the relative distances correlated with the stored image data; and the overhead image data generating device generates the overhead image data for displaying a blind spot of the imaging device using the stored image data stored in the image data storage device.

In one preferred embodiment the projection plane generating device generates a smooth plane by approximating the projection plane on the basis of the detected position of the detected obstacle.

The distance obtaining device preferably determines the presence or absence of an obstacle as well as the relative distance to the obstacle utilizing one or more sonar devices mounted on the vehicle.

The projection plane image is generated on the basis of the relative distance between the obstacle and the vehicle and image data is displayed on the generated projection plane. Therefore, the obstacle near the vehicle in the generated image data is displayed as close to an actual view as possible, in an overhead image based on the overhead image data, so that the relative distance to the obstacle is displayed in the overhead image in a manner easily understood by the driver.

In a preferred embodiment a pixel area corresponding to an actual area where no obstacle is detected is displayed on a horizontal (first) plane and a pixel area corresponding to an actual area in which an obstacle is detected is displayed on a second plane which is at a predetermined angle to the horizontal plane. An image based on overhead image data is thereby displayed, which displayed image closely resembles an actual view.

The present invention has the capability of displaying an area within a blind spot of the imaging device, so that, for example, a white line or a wheel stopper may be displayed in an overhead image, even as the vehicle enters a target parking area.

A smooth plane may be generated as a projection plane on the basis of the position of a detected obstacle. Therefore, a part of the projection plane which is totally different from an actual view is approximated and the display derived from overhead image data resembles an actual view as closely as possible.

The distance obtaining means preferably determines presence or absence of an obstacle as well as a relative distance on the basis of input from a sonar device mounted on the vehicle.

### BRIEF DESCRIPTION OF THE DRAWINGS

FIG. 1A is a block diagram of an embodiment of a driving assist apparatus according to the present invention; FIG. 1B is a block diagram of the control section 10 of the embodiment shown in FIG. 1A; and FIG. 1C is a block diagram of image processor 15 of the embodiment shown in FIG. 1A.

FIG. 2 shows a vehicle body outline.

FIG. 3A is a diagram showing a mounting position of a sonar device and FIG. 3B is a diagram showing a mounting position of a camera.

FIG. 4 shows a rear monitor screen.

FIG. 5 is a flowchart of one routine employed in an embodiment of the method of the present invention.

FIG. 6 is a flowchart of another routine employed in an embodiment of the method of the present invention.

FIG. 7 is a flowchart of yet another routine employed in an embodiment of the method of the present invention.

FIG. 8A illustrates imaging of the area behind the vehicle with the camera and FIG. 8B is a diagram illustrating image data for the area behind the vehicle and FIG. 8C is a diagram illustrating the stored image data.

FIG. 9 illustrates measurement of a relative distance to an obstacle near the vehicle.

FIG. 10 is a diagram of an overhead image.

FIG. 11 is a diagram of a support screen.

### DESCRIPTION OF THE PREFERRED EMBODIMENTS

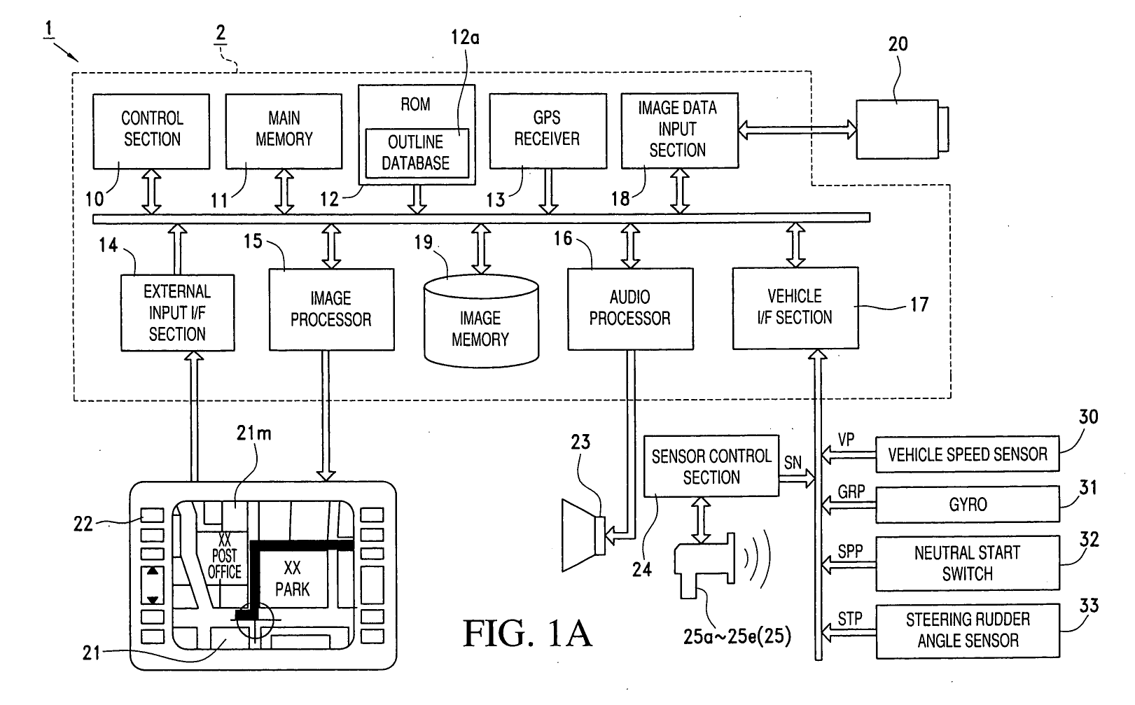

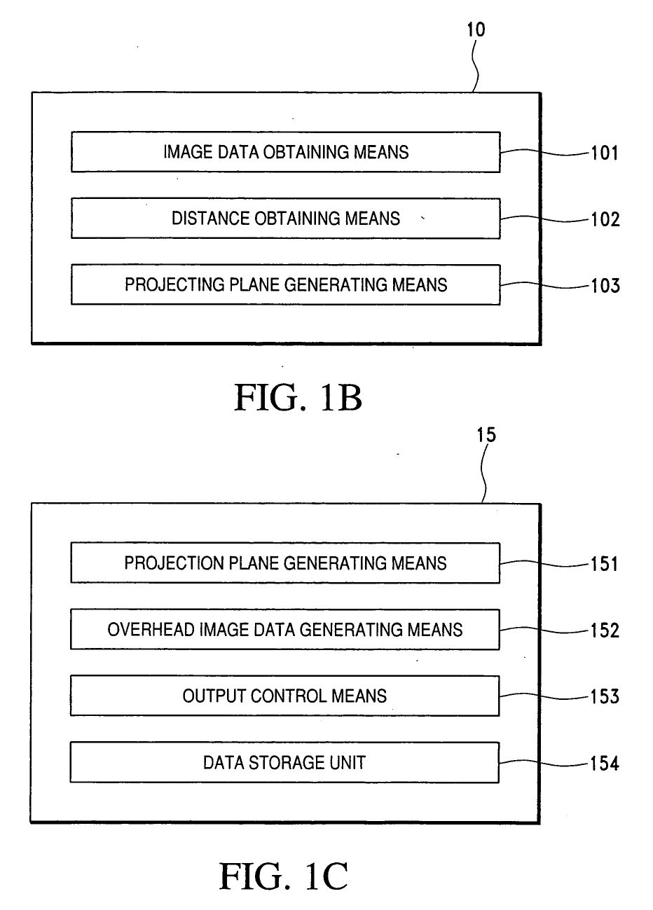

An embodiment of the present invention is described below with reference to FIGS. 1A through 11. FIG. 1A is a block diagram showing a structure of a driving assist apparatus 1 mounted in a vehicle.

As shown in FIG. 1A, a navigation unit 2 in the driving assist apparatus 1 includes a control section 10, a main memory 11 and an ROM 12. As shown in FIG. 1B, the control section 10 includes image data obtaining means 101, distance obtaining means 102, and projection plane generating means 103. The control section 10 includes a computer used mainly for control based on, for example, a route guidance program, a driving assist program, and various other programs stored in the ROM 12. The main memory 11 temporarily stores results calculated by the control section 10 and further stores variables and flags used in driving assistance.

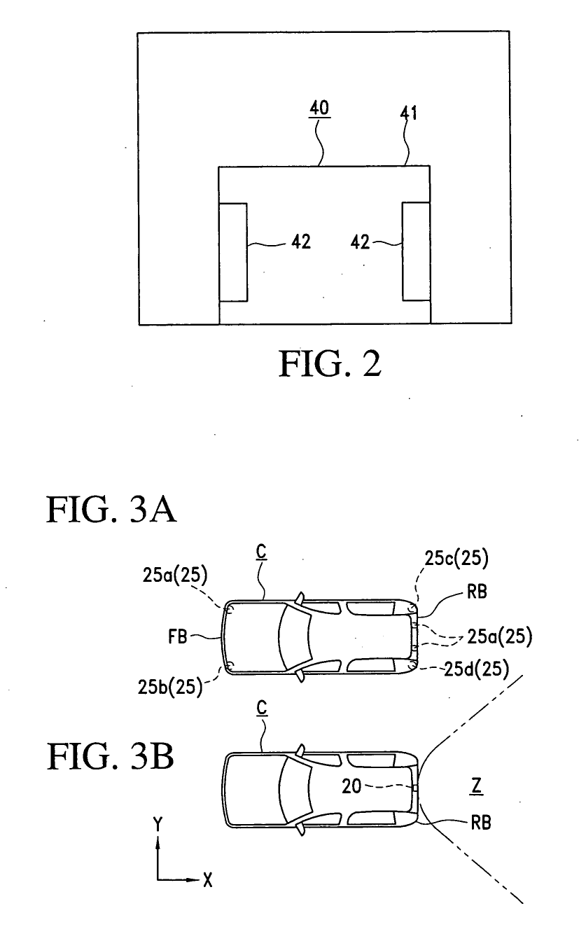

The ROM 12 stores outline data 12a used in indicating the current position of vehicle C. The outline data 12a is used to output an outline of the vehicle C (in FIG. 3), equipped with the driving assist apparatus 1, on a display 21 (display means). When the outline data 12a is output on the display 21, a vehicle outline 40 as an indicator is displayed as shown in FIG. 2. The vehicle outline 40 includes a vehicle body outline 41, representing the body of the vehicle, and a wheel outline 42. The vehicle body outline 41 is the contour of the vehicle as it would be projected from above onto a road surface. The wheel outlines 42 represent the rear wheels of the vehicle C. The vehicle body outline 41 and the wheel outline 42 respectively represent the outlines of the vehicle body and the rear wheels as seen from a virtual viewpoint above the rear bumper RB (in FIG. 3A).

As shown in FIG. 1, the navigation unit 2 includes a GPS receiver 13. The control section 10 regularly calculates the absolute coordinates of the vehicle C such as the latitude, the longitude, and the altitude, on the basis of position detection signals received from the GPS receiver 13.

The display 21 in the driving assist apparatus 1 is a touch panel. When the vehicle moves forward, an image processor 15, shown in FIG. 1C as including projection plane generating means 151, overhead image data generating means 152, and output control means 153, outputs map drawing data stored in a data storage unit 154 and displays a map screen 21m as shown in FIG. 1A. When a driver inputs information by use of the touch panel or by use of an operation switch 22 located next to the display 21, an external input interface (hereinafter referred to as an external input I/F section 14) in the navigation unit 2 outputs a signal, corresponding to the user's input, to the control section 10.

The navigation unit 2 includes an audio processor 16. The audio processor 16 includes a memory (not shown) storing an audio file and/or a digital/analog converter, and outputs audio guidance and/or an alarm from a speaker 23 in the driving assist apparatus 1, using the audio file.

The navigation unit 2 further includes a vehicle interface section (vehicle I/F section 17). The control section 10 receives as input a vehicle speed pulse VP and a direction detection signal GRP from a vehicle speed sensor 30 and a gyro 31 mounted in the vehicle C, through the vehicle I/F section 17. The control section 10 determines whether the vehicle is moving forward or backward on the basis of the waveform of the vehicle speed pulse VP and calculates the amount of the movement Ad of the vehicle C on the basis of an input pulse number. The control section 10 updates a current direction GR as a variable stored in the main memory 11 on the basis of the direction detection signal GRP. The control section 10 further calculates a relative position and a relative direction by autonomous navigation using the vehicle speed pulse VP and the direction detection signal GRP and corrects the vehicle position obtained by the GPS receiver 13. In the present embodiment, a point located at the center of the rear bumper RB of the vehicle C is used as the vehicle position.

The control section 10 receives a shift position signal SPP from a neutral start switch 32 of the vehicle C through the vehicle I/F section 17 and updates the shift position SP stored as a variable in the main memory 11. The control section 10 also received a steering sensor signal STP from a steering rudder angle sensor 33 through the vehicle I/F section 17 and updates the current rudder angle STR of the vehicle C stored in the main memory 11 on the basis of the steering sensor signal STP.

The control section 10 receives a sonar signal SN indicating the relative distance between the vehicle and an obstacle near the vehicle from a sensor control section 24 in the vehicle C, through the vehicle I/F section 17. The sensor control section 24 is a computer for processing input signals and for controlling each of a plurality of sonars (sonar devices) 25, so that the sensor control section 24 inputs/outputs various signals among the sonars 25 and thereby functions as an obstacle detecting device, as shown in FIG. 3A. The sonars 25 include a first clearance sonar (hereinafter referred to as first sonar 25a) which is mounted on the right corner of the front bumper FB and a second clearance sonar (hereinafter referred to as second sonar 25b) which is mounted on the left corner of the front bumper FB. A third clearance sonar (hereinafter referred to as a third sonar 25c) is mounted on the right corner of the rear bumper RB, a forth clearance sonar (hereinafter referred to as forth sonar 25d) is mounted on the left corner of the rear bumper RB, and a pair of clearance sonars 25e are mounted in the middle of the rear bumper RB. Herein, when there is no need to refer to an individual one of the first through forth sonars 25a through 25d and the rear sonars 25e, they will be collectively referred to as the sonars 25, as a matter of convenience.

Each of the sonars 25 includes a microphone for emitting and receiving supersonic waves and/or a control circuit for amplifying the supersonic waves (not shown). Each of the sonars 25 repeatedly outputs supersonic waves around the vehicle in a predetermined order. The sensor control section 24 calculates the relative distances Rd between each of the sonars 25 and an obstacle using the time required for supersonic waves to return to each of the sonars 25 after reflecting off the obstacle. Then the sensor control section 24 outputs the sonar signal SN, which indicates the presence or absence of an obstacle near the vehicle and the relative distance Rd between the vehicle and the obstacle, to the control section 10.

When the relative distance Rd between the obstacle and the vehicle C is determined to be equal to or less than 500 mm by the sensor control section 24, the sensor control section 24 controls the audio processor 16 to output an alarm or an audio message from the speaker 23.

The navigation unit 2 includes an image data input section 18 as an image data obtaining means. The image data input section 18 is controlled by the control section 10 and controls a rear monitor camera 20 as an imaging device mounted on the vehicle C. The image data input section 18 obtains image data G, having undergone analog/digital conversion processing by the camera 20, abstracts predetermined area data from the image data G, and then temporarily stores the stored image data G1 in an image memory 19 (image data storage means) in the navigation unit 2, in correlation with, for example, pulse numbers which have been accumulated and stored since the vehicle C initiated rearward movement from an initial position.

The camera 20 is attached to a rear part of the vehicle C, such as the rear door of the vehicle C as shown in FIG. 3B, and the optical axis of the camera 20 is directed downward. The camera 20 is a digital camera for imaging color images and may have optics (not shown) such as, a wide-angle lens and a mirror, and a CCD image sensor (not shown). The viewing range Z of the camera 20 may be about several meters from the center of the rear bumper RB of the vehicle C.

The image processor 15 may include a calculating section for image processing and a VRAM for temporarily storing output data for display on the display 21. The image processor 15 is controlled by the control section 10 to generate a composite image using the image data G1 stored in the image memory 19.

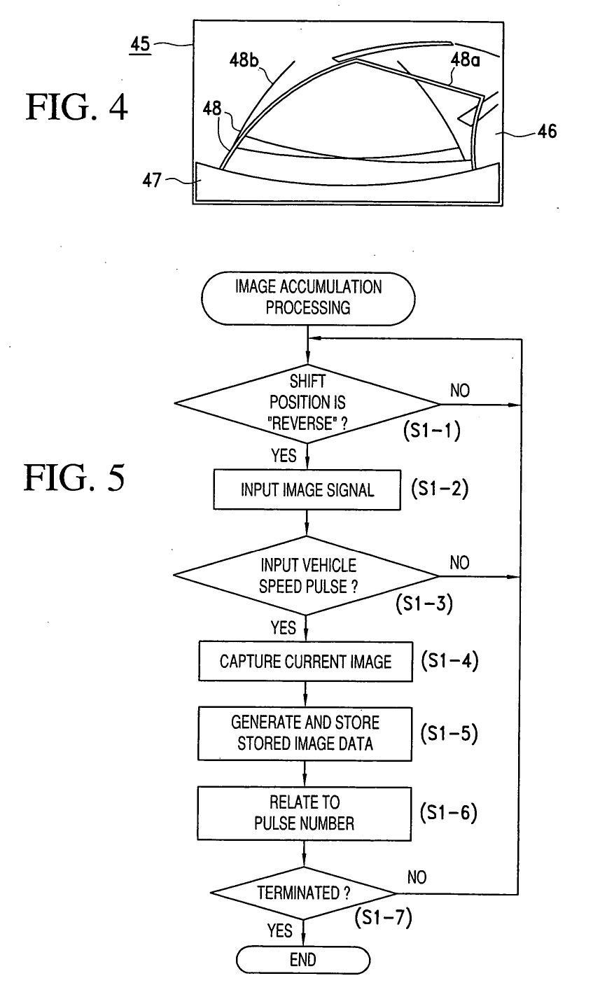

The image processor 15 outputs an image signal from the camera 20 at a predetermined time and displays a rear monitor screen 45 on the display 21 as shown in FIG. 4. In the rear monitor screen 45, a background image 46, including the area behind the vehicle C and a vehicle rear portion image 47 including the rear bumper RB, are displayed together as a composite image. The background image 46 is distorted due to lens aberration since the camera 20 has a wide-angle lens. Further, the background image 46 is a mirror-reversed image of the image signal from the camera 20 to simulate the view of the area behind the vehicle as the driver would see it in the rearview mirror. Therefore, an obstacle located near the right rear of the vehicle C is displayed on the right side of the background image 46 and an obstacle located near the left rear of the vehicle C is displayed on the left side of the background image 46.

The image processor 15 superimposes a guide line 48 on the background image 46. The guide line 48 may include a probable movement locus 48a, drawn in accordance with the current rudder angle STR of the vehicle C, and an extended line 48b indicating the width of the vehicle C.

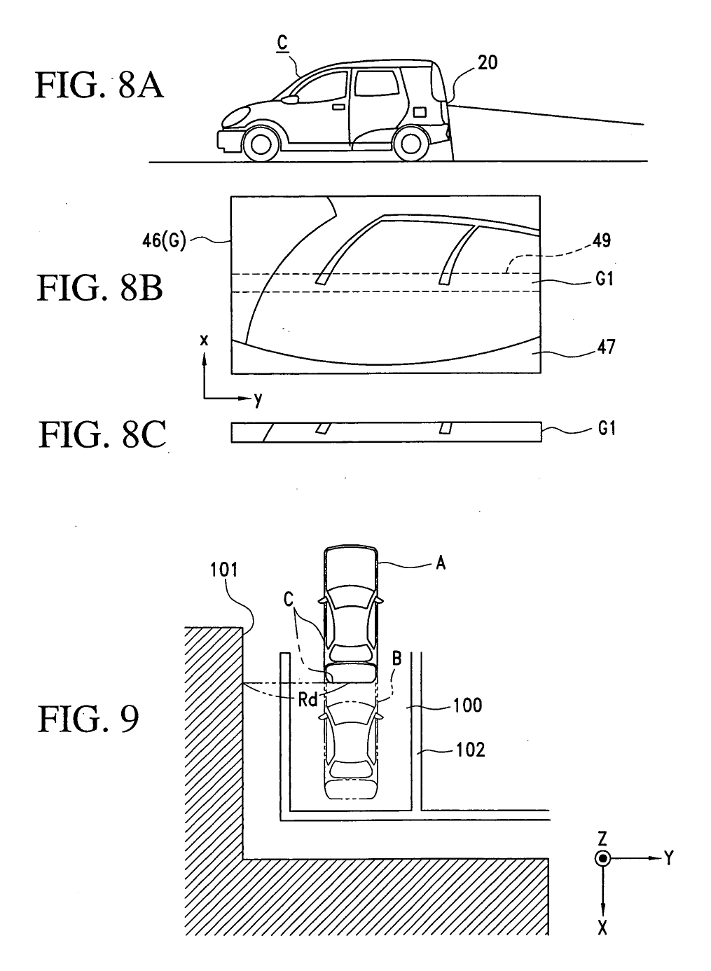

Next, the driving assist method of the present invention will be described with reference to FIGS. 5 through 7 below. The control section 10 receives the shift position signal SPP from the neutral start switch 32 in execution of a driving assist program stored in the ROM 12 and waits until the current shift position SP is changed to “reverse” (Step S1-1). When the shift position SP is changed to“reverse”, the control section 10 controls the camera 20 to output an image signal for an image including the area behind the vehicle (Step S1-2). As shown in FIG. 8A, the camera 20 images an area extending several meters behind the vehicle. Immediately after the vehicle moves backward, the image processor 15 outputs the image signal on the display 21 and displays the background image 46 on the display 21 as shown in FIG. 8B.

The control section 10 determines whether the vehicle speed pulse VP is input from the vehicle speed sensor 30 (Step S1-3). When the vehicle speed pulse VP is received as input, the routine returns to Step S1-1. When it is determined that the vehicle speed pulse VP is input (Step S1-3=YES), that is, when the vehicle C moves backward, the control section 10 adds the input vehicle speed pulse to the accumulated pulse number Tp stored in the main memory 11. Then the control section 10 captures the background image 46 as shown in FIG. 8B (Step S1-4), abstracts an area 49 from the obtained image data G, generates stored image data Gi from the abstracted area 49, and stores the generated image data GI (Step S1-5).

After generating the stored image data Gi, the control section 10 correlates the stored image data Gi with the accumulated pulse number Tp (Step S1-6). The foregoing routine is repeated for each image captured to accumulate plural items (blocks) of data G1. In this case, a table of the accumulated pulse number Tp and the stored image data G1 correlated therewith may be created, or the accumulated pulse number Tp may be attached as a header.

The control section 10 determines whether or not the image accumulation processing is terminated (Step S1-7). For example, the control section 10 determines that image accumulation processing is terminated when an off signal is received from an ignition module (not shown). When it is determined that image accumulation processing is not terminated (Step S1-7=NO), the routine returns to Step S1-1.

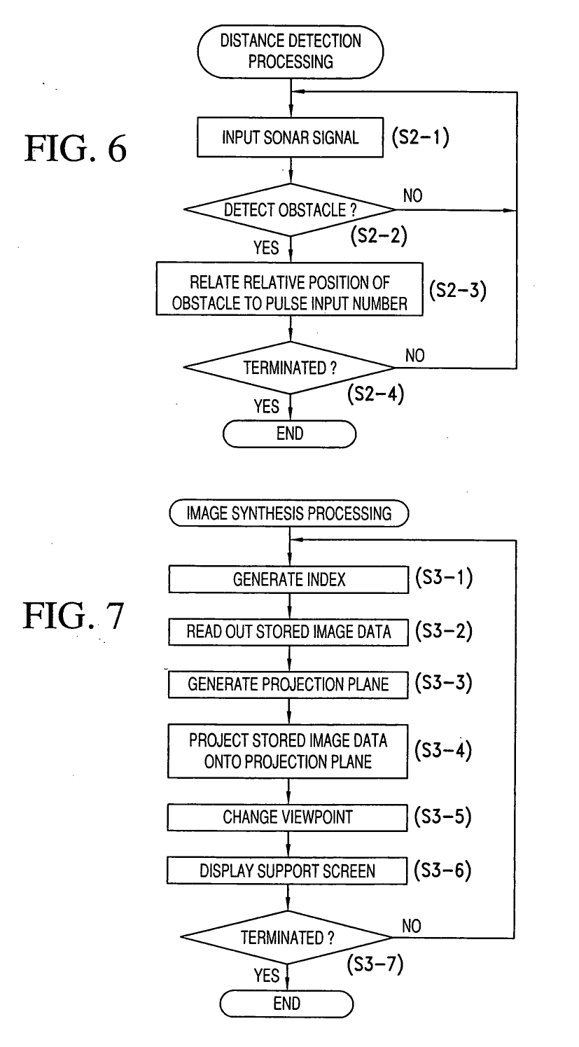

The control section 10 executes a distance detection processing as shown in FIG. 6 in parallel with execution of image accumulation processing. First, the control section 10 inputs the sonar signal SN from the sensor control section 24 (Step S2-1). For example, when the vehicle C is located at a position A in FIG. 9, the sensor control section 24 determines whether or not there is an obstacle near the vehicle C on the basis of signals from the sonar 25. For example, when the fourth sonar 25d which is mounted on the left corner of the rear bumper RB of the vehicle detects an obstacle such as a wall 101, the sensor control section 24 calculates the relative distance Rd between a predetermined position of the vehicle C, such as the center of the rear bumper RB of the vehicle C, and the wall 101 located near a parking target area 100. Then the sensor control section 24 outputs the sonar signal SN, including information as to the presence or absence of the obstacle and the relative distance Rd to the obstacle, to the control section 10.

The control section 10 determines whether an obstacle such as a wall or another parked vehicle near the vehicle C is detected on the basis of the input sonar signal SN (Step S2-2). When it is determined that such an obstacle is not detected (Step S2-2=NO), the routine returns to Step S2-1.

When it is determined that an obstacle is detected (Step S2-2=YES), the control section 10 stores the relative distance Rd, based on the sonar signal SN, in the main memory 11 and correlates the relative distance Rd with the accumulated pulse number Tp at a given time (Step S2-3). The relative distance Rd between the obstacle and the vehicle C here means the relative distance between the obstacle and a predetermined position on the vehicle C (for example, the center of the front bumper of the vehicle C). As a result, the accumulated pulse number Tp, indicating the distance the vehicle C has moved backward from the initial position to the current position, the relative distance Rd between the current vehicle position and the obstacle, and the stored image data G1 obtained at the current vehicle position are correlated with each other.

Then the control section 10 determines whether distance detection processing is terminated (Step S2-4). When it is determined that distance detection processing is not terminated (Step S2-4=NO), the routine returns to Step S2-1.

Next, the control section 10 controls the image processor 15 to execute image synthesis processing as shown in FIG. 7. The image synthesis processing is executed in parallel with the image accumulation processing and the distance detection processing described above. The control section 10 determines that the stored image data G1 is sufficient to generate overhead image data and, if sufficient, generates an index to read out the stored image data G1 (Step S3-1). The number of indexes to be generated is determined by subtracting the accumulated pulse numbers Tp stored in the main memory 11 from a predetermined number of pulse numbers. More specifically, an index is used for reading out the items (blocks) of stored image data G1 obtained at each of plural positions at predetermined distances (for example, 100 mm) from the current position of the vehicle C.

The image processor 15 reads out the stored image data G1, as being related to a generated index, from the image memory 19 (Step S3-2). Then the image processor 15 reads out from the main memory 11 the relative distance Rd to the obstacle which is correlated with each accumulated pulse number Tp indicated by one of successively generated indexes and utilizes the data thus read out to generate a projection plane image (Step S3-3).

More specifically, the image processor 15 relates coordinates in a vehicle coordinate system (X-axis, Y-axis, and Z-axis coordinates as shown in FIG. 9), corresponding to each of the accumulated pulse numbers Tp, to pixel coordinates in a screen coordinate system (x-axis, y-axis, and z-axis coordinates (see FIG. 8B)). A range in the screen coordinate system, corresponding to the actual area in the vehicle coordinate system in which no obstacle is detected, is displayed on a horizontal plane (first plane) defined by the x-axis and y-axis. Also a range in the screen coordinate system, corresponding to the actual area in the vehicle coordinate system in which an obstacle is detected, is displayed on a second plane which is at a predetermined angle to the horizontal plane, i.e. an angle predetermined on the basis of the detected relative distance Rd. The second plane includes at least a z-coordinate, so that the plane may be at a right angle to the horizontal plane, indicating a road face, or at another predetermined angle to the horizontal plane. Then, a projection plane image which takes into account the positions of obstacles in both the second plane and the horizontal plane, connected with each other, is generated. When no obstacle is detected, the projection plane has only the horizontal plane defined by the x-axis and the y-axis. In this case, if there is an obstacle which is located far from a median position among the detected obstacles (for example, an obstacle located at a distance 10% or more greater than the median distance), the position of the distant obstacle is replaced by the median value and the projection plane is approximated as a smooth plane. When the sonar 25 detects the relative distance Rd, including Z-axis coordinates in the vehicle coordinate system, for example a slope and/or an irregularity of the wall 101 is indicated by each of the planes described above.

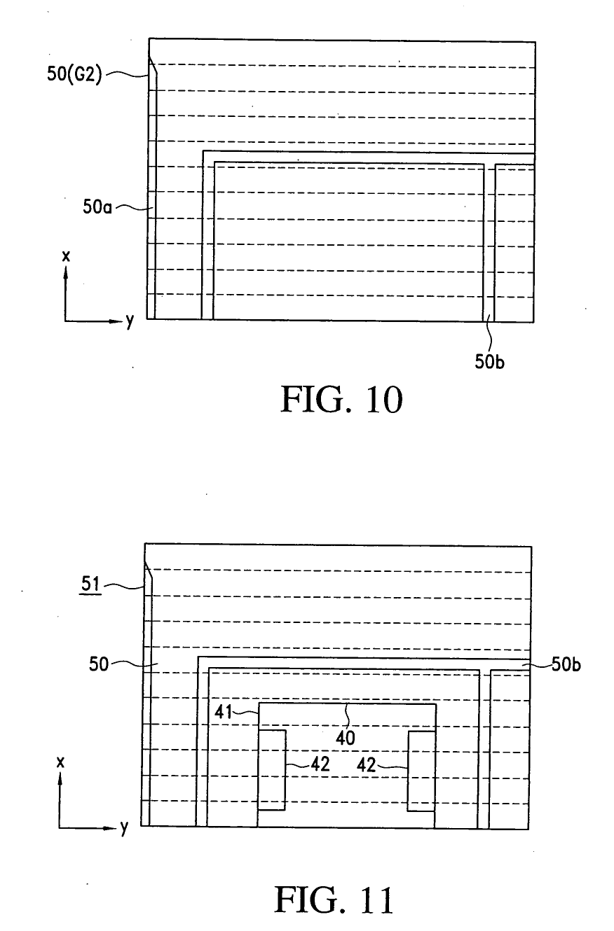

After reading out the stored image data G1, the image processor 15 arranges the stored image data G1 on the generated projection plane in an array along the direction of movement of the vehicle C (x-direction), that is, each item of stored image data G1 is projected onto the generated projection plane (Step S3-4). After projecting the stored image data G1 onto the projection plane, the image processor 15 changes the viewpoint of the stored image data G1 from the current viewpoint of the camera to a virtual viewpoint set vertically above the current viewpoint (Step S3-5). As a result, overhead image data G2 is generated as shown in FIG. 10. FIG. 10 is a diagram showing the overhead image data G2 generated when the vehicle C enters the parking target area 100 as shown in FIG. 9. The overhead image 50, based on the overhead image data G2, includes the parking target area 100 located under the rear portion of the vehicle C. That is, although the parking target area 100 is currently in the camera's blind spot since the area is under the vehicle C, the parking target area 100 and a white line 102 defining the parking target area 100 (in FIG. 9) are displayed in an image 50b (in FIG. 10). Further, an image 50a including a wall 101 near the vehicle C is projected on a vertical projection plane, so that the wall 101 is displayed on the projection plane as if the wall is at a right angle to the road surface.

After generating the overhead image data G2, the image processor 15 superimposes the overhead image 50 and the vehicle body outline 40 on a support screen 51 as shown in FIG. 11 (Step S3-6). By viewing the image 50b, including the white line 102 and the vehicle body outline 40, displayed on the support screen 51, the driver can see the position of the vehicle C relative to the target parking area 100. Further, the driver may check the wheel outline 42 and the relative distance between the vehicle C and, for example, a wheel stopper, so that the driver may control the impact with the wheel stopper in parking.

After the support screen 51 is displayed, it is determined whether or not a series of steps of the routine should be terminated (Step S3-7). When it is determined that the series of steps should be terminated (Step S3-7=YES), the routine is terminated. When it is determined that the series of steps should be terminated (Step S3-7=NO), the routine returns to Step S3-1.

The embodiment described above provides the user with the following advantages.

1)Because the obstacle near the vehicle C is displayed on the overhead image 50 based on the generated overhead image data G2 in a manner as close to an actual view as possible, it is easy for the driver to recognize the actual distance to the obstacle displayed in the overhead image 50, and to avoid impact with the obstacle during parking, i.e. to park the vehicle C while keeping an appropriate distance between the vehicle C and the obstacle.

2) Because the image processor 15 generates a smooth projection plane on the basis of each of the relative distances Rd detected by the sonar 25, the stored image data G1 displayed as the overhead image 50 on the projection plane may be easily understood by the driver.

3) Because the white line and/or the wheel stopper which is currently located under the vehicle C may be displayed together with the vehicle body outline 40 in the overhead image 50, the driver may see and understand the position of his vehicle C relative to the white line or the wheel stopper.

Various modifications of the embodiment described above include the following.

While in the above-described embodiment, the stored image data G1 is arranged in the direction of the movement of the vehicle C to generate overhead image data G2, a composite image may be generated in another manner.

In the above-described embodiment, the control section 10 receives the shift position signal SPP from the neutral start switch 32 through the vehicle I/F section 17. However, the signal may be received from another device such as a transmission ECU. Also, the control section 10 may determine that the vehicle C is moving backward solely on the basis of the waveform of the vehicle speed pulse VP.

The sensor control section 24 may be incorporated into the driving assist apparatus 1.

The control section 10 may determine whether an obstacle is a movable body on the basis of the sonar signal SN input from the sensor control section 24. When it is determined that the obstacle is a movable body, there may be no need to generate a projection plane.

In the above-described embodiment, the relative distance Rd to the obstacle is detected by use of the sonar 25. However, alternatively, the relative distance Rd may be calculated by processing image data G obtained from the camera 20.

The camera 20 may be mounted on a front portion of the vehicle C, e.g. on the top of the front bumper, instead of on a rear portion of the vehicle C.

In the above-described embodiment, the stored image data G1 is stored in the image memory 19 and is used for display of the support screen 51. However, the driving assist apparatus 1 may project only the most recently obtained image data G on a projection plane, without using stored (previously obtained) image data G1. In this case, an image which enables the driver to understand the relative distance to the obstacle may be displayed to assist the driver in driving a narrow road.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A driving assist method for generating an overhead image from image data obtained from successive images captured by an imaging device mounted on a vehicle, comprising the steps of:
obtaining relative distances between the vehicle and an obstacle based on signals from an obstacle detection device mounted on the vehicle as the vehicle moves;
correlating the image data obtained from successive images with the relative distances; and
projecting the image data on a projection plane to generate the overhead image.

2. A driving assist apparatus mounted in a vehicle, comprising:
image data obtaining means for obtaining image data from successive images output by an imaging device mounted on the vehicle as the vehicle moves;
distance obtaining means for detecting an obstacle near the vehicle and for determining relative distances between the vehicle and the obstacle;
overhead image data generating means for correlating the image data with the relative distances and for projecting the image data output by the imaging device onto a projection plane to generate overhead image data; and
output control means for outputting the overhead image data on a display.

3. The driving assist apparatus according to claim 2, wherein the output control means comprises:
projection plane generating means for generating a horizontal plane including a pixel area corresponding to an actual area containing no detected obstacle, and for generating a second plane including a pixel area corresponding to an actual area containing a detected obstacle, the second plane being at a angle to the horizontal plane, the angle being predetermined in accordance with the relative distance to the obstacle, the second plane being used to calculate positions of features of the detected obstacle relative to the horizontal plane in three dimensions, for use in generating the overhead image data.

4. The driving assist apparatus according to claim 2, further comprising:
image data storage means for storing the image data as items of stored image data, each item of stored image data correlated with the relative distance to the obstacle obtained at an imaging position where that item of image data was obtained; wherein:
the overhead image data generating means generates the overhead image data for displaying a blind spot of the imaging device using the stored image data stored in the image data storage means.

5. The driving assist apparatus according to claim 3, further comprising:
image data storage means for storing the image data as stored image data correlated with the relative distance to the obstacle obtained at an imaging position where the image data was obtained; wherein:
the projection plane generating means generates the projection plane on the basis of the relative distance correlated with the stored image data; and
the overhead image data generating means generates the overhead image data for displaying a blind spot of the imaging device using the stored image data stored in the image data storage means.

6. The driving assist apparatus according to claim 2, wherein:
the projection plane generating means generates a smooth plane by approximating the projection plane on the basis of a position of the detected obstacle.

7. The driving assist apparatus according to claim 2, wherein:
the distance obtaining means detects a presence or absence of an obstacle or determines relative distance based on input from a sonar device mounted on the vehicle.
